(19) United States
(12) Patent Application Publication
(10) Pub. No.: US 2011/0168817 A1
(43) Pub. Date: Jul. 14, 2011

(54) CONTRASTING DEVICE FOR A SHREDDING PLANT

(75) Inventors: John Lester, Worksop (GB); Craig Rose, Sheffield (GB)

(73) Assignee: DANIELI DAVY DISTINGTON LTD., Sheffield (GB)

(21) Appl. No.: 13/001,207

(22) PCT Filed: Jun. 24, 2009
(86) PCT No.: PCT/EP09/57913

§ 371 Date: Mar. 15, 2011

(30) Foreign Application Priority Data
Jun. 26, 2008 (IT) UD2008A000151

(51) Int. Cl. B02C 23/00

(52) U.S. Cl. 241/101.1

(57) ABSTRACT

A contrasting device for a shredding plant comprising shredding members for shredding. The contrasting device comprises one or more contrast portions assembled in an independent and removable manner onto a frame of the plant, and assembly elements cooperating with each contrast portion, so as to determine the independent and removable assembly onto the frame. Each contrast portion comprises a symmetrical contrast profile with respect to a contrast edge. The profile is defined by a first segment and by a second segment substantially equal to each other.

### FIELD OF THE INVENTION

The present invention concerns a contrasting device which can be used, advantageously but not in limiting way, in a shredder unit of a plant for shredding, for example scrap, such as vehicles, trailers or others, into which the scrap is loaded whole and shredded by means of one or more drums with hammers, so as to reduce the bulk and to sub-divide the different materials of which the scrap is made up, for example metal, glass, plastic or other. In particular, the contrasting device according to the present invention is functionally housed in correspondence with the zone of action of the drum with hammers in order to maintain the scrap in such a position that it effectively undergoes the action of the drum with hammers.

### BACKGROUND OF THE INVENTION

Plants for shredding scrap are known, such as vehicles, trailers or others, into which the scrap is loaded substantially whole and is shredded both to reduce its bulk, and to separate efficiently the materials that make it up.

Known plants for shredding scrap comprise a shredder unit provided with a drum disposed rotatable inside a shredding chamber, and with respect to which the scrap is fed through a feed pipe.

The drum normally has a plurality of hammers distributed angularly on the external circular surface of the drum, which, following the rotation of the drum, violently hammer against the scrap and thus shred it.

A shredder unit is also known that provides one or more contrasting elements disposed in correspondence with an entry zone of the shredding chamber.

The contrasting elements are conformed so as to maintain the scrap close to the zone of action of the drum in such a position that it undergoes the action of the hammers efficiently.

The contrasting elements of known plants comprise one or more contrast portions assembled on a frame and disposed on the entire length of the drum.

Each contrast portion is assembled on the frame in a replaceable manner, by means of a relative assembly member, normally a screw.

The contrast portions are equal to each other and each has a contrast profile defined by an inclined upper segment, defining a contrast edge facing towards the drum.

The contrast portions are subjected to heavy wear, and the contrast edge is progressively blunted and consumed by the passage of the scrap under the action of the drum.

Furthermore, each contrast portion comprises a housing seating made inside the usable contrasting thickness of the contrast portion, and in which a clamping head of the assembly member is able to be disposed.

The assembly member also comprises, normally, a threaded rod with which it is attached to the frame.

This conformation entails that the wear on the contrast portion also affects the clamping head of the assembly member. This entails an inefficient assembly action of the assembly member and the need for it to be replaced together with the relative contrast portion.

Furthermore, each contrast portion is disposed in a positioning compartment made on the frame, and contacts the compartment substantially with all the external surfaces not involved in contrasting the scrap.

There is therefore a need to provide specific mechanical workings both in the positioning compartment, and on the external surfaces of each contrast portion, with a consequent increase in the time and costs of production.

A purpose of the present invention is to achieve a contrasting device for a scrap-shredding plant that is simple and economical to make, that does not need frequent replacements and that performs an efficient contrasting action on the scrap with controlled wear.

Other purpose of the present invention is that every section of the device, may be used in an other relative position if it result weared.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purposes, a contrasting device according to the present invention can be employed in shredding plants, in order to maintain the materials to shred, for example scarp, in contact with the relative shredding means.

The contrasting device according to the invention comprises one or more contrast portions assembled in an independent and removable manner on a frame of the plant, and assembly means cooperating with each contrast portion so as to determine its independent and removable assembly on the frame.

According to a characteristic feature of the present invention, each contrast portion comprises a symmetrical contrast profile defined by a first segment, for the entrance of the scrap, and by a second segment, for the discharge of the scrap. Said first and second segments are substantially equal to one another, and able to define a relative contrast edge that faces the shredding means.

In this way, every profile may be rotated of 180°, when the wear on the contrast edge allows it.

Further, the contrast portions can be selectively their position exchanged, in order to present to the entering scrap the segment that is not worn.

It is therefore possible to re-use the contrast portions efficiently, with a consequent reduction in maintenance costs and maintenance time caused by the wear on the contrasting device.

According to a variant, each contrast portion comprises an attachment element with which the assembly means are able to cooperate so as to determine the assembly of the relative contrast portion on the frame.

In particular, the attachment element extends outside the usable contrasting thickness of the contrast portion.

In this way, the possible wear of the contrast portion caused by the passage of the scrap never affects either the attachment element, or the assembly means, constantly guaranteeing a secure assembly of the relative contrast portion on the frame.

According to another variant, each contrast portion has a substantially V-shaped cross section, in which the top is defined by the contrast edge, while the ends opposite the top define relative edges resting on the frame.

Therefore each contrast portion comprises only two edges resting on the frame, and not all the surfaces not affected by the contrast as in the state of the art.

This variant solution therefore allows to limit the mechanical workings needed both for finishing the contrast portion, and also for making a coordinated positioning compartment on the frame.

According to another variant, the attachment element is made externally to the contrast portion in a zone intermediate to the two resting edges.

The assembly means comprises, for each contrast portion, a clamping head conformed so that it may be constrained to the relative attachment element, and a threaded rod adjacent to the clamping head and able to cooperate with a coordinated threaded member so as to define the assembly of the relative contrast portion to the frame.

According to a further variant, the attachment element and the assembly means are reciprocally conformed in order to perform an assembly action on the relative contrast portions, according to a direction substantially inclined with respect to the bisector of the angle formed by the first and second segment of the symmetrical profile.

This variant guarantees an efficient support of the two resting edges determining an excellent positioning stability of the relative contrast portion on the frame.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic and partially sectioned lateral view of a scrap-shredding plant to which a contrasting device according to the present invention is applied;

FIG. 2 is an enlarged detail of FIG. 1;

FIG. 3 is a schematic front view of the detail of FIG. 2.

### DETAILED DESCRIPTION OF A PREFERENTIAL FORM OF EMBODIMENT

With reference to the attached drawings, a contrasting device 10 according to the present invention is applied at the entrance to a shredding chamber 11 of a plant 12 for the shredding of scrap. Inside the shredding chamber 11 a drum 13 with hammers is provided, which performs a hammering and shredding action on the scrap.

In particular, the contrasting device 10 according to the present invention is assembled on a frame 15 of the plant 12, immediately downstream of a feed pipe 16 for the scrap, so as to maintain the fed scrap close to the drum 13 with hammers and emphasize the efficient hammering and shredding action thereof.

The contrasting device 10 according to the invention comprises a plurality of contrast portions 17, in this specific case six, disposed in a line one after the other along the length of the drum 13 (FIG. 3).

It is not excluded that in other solutions, alternative to or able to be combined with the one shown, a different number, also uneven, of contrast portions 17 can be provided, that is, two or more rows of contrast portions 17.

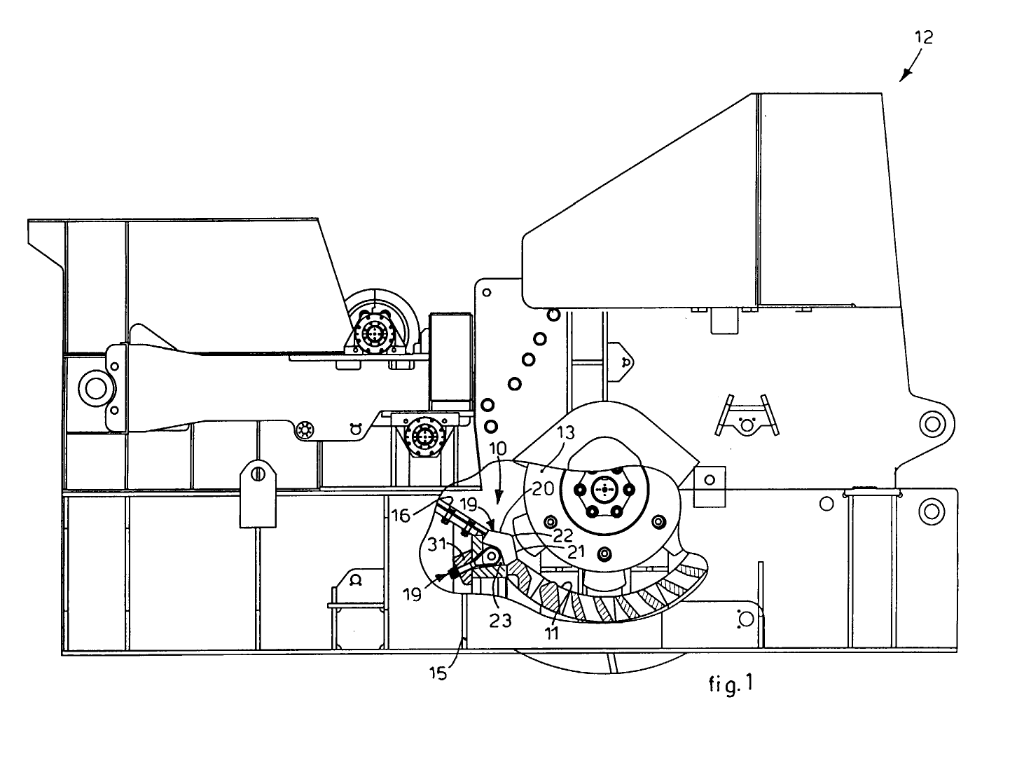

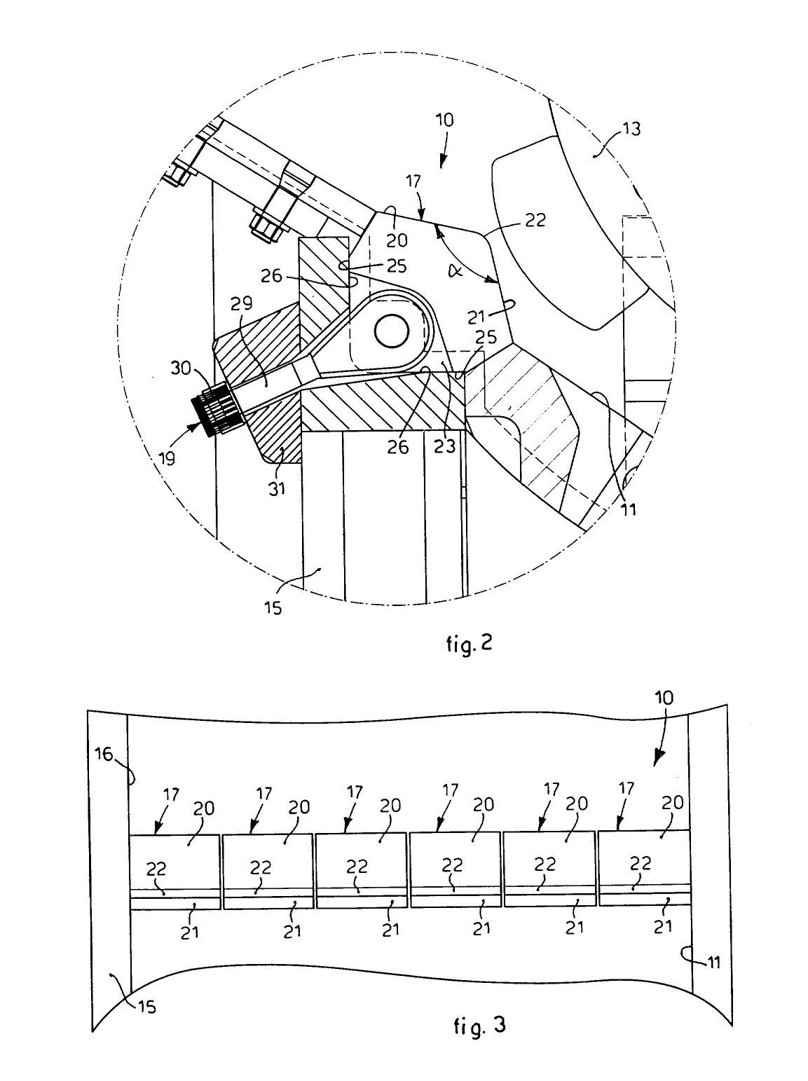

The contrasting device 10 also comprises, for each contrast portion 17, a specific assembly member 19 that allows the independent and removable assembly of the relative contrast portion 17 on the frame 15 (FIGS. 1 and 2).

Each contrast portion 17 comprises a usable contrasting section which has a contrast profile facing towards the drum 13 and defined by an entrance segment 20 and an exit segment 21. The entrance segment 20 and the exit segment 21 are equivalent in size and intersect in a median zone of the contrast profile, conforming the latter in a substantially symmetrical manner.

The intersection between the entrance segment 20 and the exit segment 21 defines a contrast edge 22 facing towards the hammer drum 13.

In this specific case, the entrance segment 20 and the exit segment 21 reciprocally intersect defining an angle a comprised between about 90° and about 130°, advantageously comprised between about 110° and about 120°.

In this specific case, each contrast portion 17 is therefore substantially V-shaped, wherein the contrast edge 22 defines the top of said conformation.

The two ends opposite the top define, instead, two respective resting edges 25 able to rest on and contact respective supporting walls 26 of the frame 15, so as to define the secure and stable positioning of the relative contrast portion 17 to the frame 15.

The resting edges 25 are the only parts of the contrast portion that contact the frame 15.

Each contrast portion 17 also comprises an attachment element 23 made externally with respect to the usable contrasting section and on the side opposite the contrast profile.

The attachment element 23 is disposed in a median zone with respect to the two resting edges 25, and is conformed so as to cooperate with the assembly member 19, in order to define the assembly of the relative contrast portion 17 to the frame 15.

In particular, the conformation of the attachment element 23 is such that it allows the assembly member 19 to perform an assembly action towards the frame 15 along a direction inclined with respect to the bisector of the angle α.

The inclination of the assembly action performed by the assembly member 19 is such that it determines a stronger assembly action on the resting edge 25 closest to the feed pipe 16.

In this way, the action of hammering and shredding performed by the hammer drum 13 on the scrap is more efficiently contrasted.

The assembly member 19 comprises a clamping head 27 able to be constrained, in this specific case by pivoting, to the attachment element 23, and a threaded rod 29, connected behind the clamping head 27.

The assembly member also comprises a clamping nut 30 able to be screwed to a free end of the threaded rod 29 and to cooperate with a coordinated block 31 of the frame 15, so as to determine the clamping of the assembly member 19 to the frame 15, and therefore the operational positioning of the relative contrast portion 17.

The symmetrical conformation of each contrast portion 17 is such that, when the entrance segment 20 is particularly worn by the rubbing action of the scrap, the clamping nut 30 can be loosened, and the relative contrast portion 17 can be rotated by 180° with respect to the bisector of the angle α, so as to invert the position of the entrance segment 20 with the position of the exit segment 21, and vice versa.

In this way, without replacing the contrast portion 17, a non-worn segment, the exit segment 21, is suitable to perform the contrast action on the scrap fed.

It is clear, however, that modifications and/or additions of parts may be made to the contrasting device 10 as described heretofore, without departing from the field and scope of the present invention.

It is also clear that, although the present invention has been described with reference to some specific examples, a person of skill in the art shall certainly be able to achieve many other equivalent forms of contrasting device for a shredding plant, having the characteristics as set forth in the claims and hence all coming within the field of protection defined thereby.

1. A contrasting device for a shredding plant comprising shredding means able to perform a shredding and a feed pipe for feeding the scrap towards the shredding means, said device comprising one or more contrast portions assembled in an independent and removable manner onto a frame of said plant, and assembly means cooperating with each contrast portion, so as to determine the independent and removable assembly onto said frame, wherein each contrast portion comprises a symmetrical contrast profile with respect to a contrast edge, said contrast profile being defined by a first segment, for the entrance of the scrap, located immediately downstream of said feed pipe and by a second segment, for the discharge of the scarp, the two segment being substantially equal to each other.

2. The contrasting device as in claim 1, wherein the first segment and the second segment intersect reciprocally in a median zone of the contrast profile, and define the contrast edge facing towards said shredding means.

3. The contrasting device as in claim 1, wherein the first segment and the second segment intersect reciprocally defining between them an angle (α) comprised between about 90° and 130°.

4. The contrasting device as in claim 3, wherein said angle (α) is comprised between about 110° and 120°.

5. The contrasting device as in claim 1, wherein each contrast portion comprises an attachment element which extends externally to the usable contrasting thickness of the contrast portion, and with which the assembly means is able to cooperate in order to determine the assembly of the relative contrast portion onto the frame.

6. The contrasting device as in claim 1, wherein each contrast portion has a substantially V-shaped cross section, in which the top is defined by the contrast edge, while the ends opposite the top define relative edges resting on the frame.

7. The contrasting device as in claim 6, wherein the attachment element is made externally to the contrast portion in an intermediate zone between the resting edges.

8. The contrasting device as in claim 5, wherein the assembly means comprises a clamping head conformed so as to be constrained to the relative attachment element, and a threaded rod connected to said clamping head and able to cooperate with a coordinated threaded member so as to define the assembly of the relative contrast portion onto the frame.

9. The contrasting device as in claim 8, wherein the attachment element and the assembly means are reciprocally conformed so as to perform an assembly action on the relative contrast portion, in a direction substantially inclined with respect to the bisector of the angle (α) formed by the first segment and by the second segment of the contrast profile.
